(19) United States
(12) Patent Application Publication
(10) Pub. No.: US 2026/0200172 A1
(43) Pub. Date: Jul. 16, 2026

(54) SHAPING AND CUTTING MACHINE

(71) Applicant: SEIKO EPSON CORPORATION, Tokyo (JP)

(72) Inventor: Ryo KINO, SHIOJIRI-SHI (JP)

(73) Assignee: SEIKO EPSON CORPORATION, Tokyo (JP)

(21) Appl. No.: 19/446,976

(22) Filed: Jan. 13, 2026

(30) Foreign Application Priority Data
Jan. 14, 2025 (JP) 2025-004614

(51) Int. Cl. B29C 64/30; B29C 64/209; B33Y 30/00; B33Y 40/20; B33Y 70/10; B29K 505/12

(52) U.S. Cl. CPC B29C 64/30; B29C 64/209; B33Y 30/00; B33Y 40/20; B33Y 70/10; B29C 2793/009; B29K 2505/12

(57) ABSTRACT

The shaping and cutting machine includes a molding section that discharges a resin material containing metal particles and that molds a molded body and a cutting section that cuts the molded body and that forms a molded article, wherein the molding section has a plasticizing section that plasticizes the resin material and a nozzle that discharges the plasticized resin material, the cutting section includes a cutting tool having a cutting edge section that cuts the molded body, and the cutting edge section has a base material and a coating material that coats the base material and that contains chromium and silicon.

The present application is based on, and claims priority from JP Application Serial Number 2025-004614, filed January 14, 2025, the disclosure of which is hereby incorporated by reference herein in its entirety.

### BACKGROUND

### 1. Technical Field

The present disclosure relates to a shaping and cutting machine.

### 2. Related Art

A shaping and cutting machine is known that discharges a plasticized resin material from a nozzle toward a stage and that cuts the cured resin material with a cutting tool to shape a molded body having a desired shape.

For example, described in JP-A-2023-178655, a method for manufacturing a molded article, in which a molded article is molded by discharging a molding material containing a thermoplastic resin to mold a molded body and cutting the molded body with a rotary tool.

In a case where a metal such as iron is contained in a molded body to be cut, when the molded body is cut by a cutting tool, the cutting tool is likely to be damaged or worn down, and there is a possibility that the life of the cutting tool is shortened.

### SUMMARY

A shaping and cutting machine according to an aspect of the present disclosure includes a molding section that discharges a resin material containing metal particles and that molds a molded body and a cutting section that cuts the molded body and that forms a molded article, wherein the molding section has a plasticizing section that plasticizes the resin material and a nozzle that discharges the plasticized resin material, the cutting section includes a cutting tool having a cutting edge section that cuts the molded body, and the cutting edge section has a base material and a coating material that coats the base material and that contains chromium and silicon.

### BRIEF DESCRIPTION OF THE DRAWINGS

FIG. 1 is a perspective view schematically illustrating a shaping and cutting machine according to the present embodiment.

FIG. 2 is a cross-sectional view schematically illustrating a molding section of the shaping and cutting machine according to the present embodiment.

FIG. 3 is a perspective view schematically illustrating a flat screw of the shaping and cutting machine according to the present embodiment.

FIG. 4 is a plan view schematically illustrating a barrel of the shaping and cutting machine according to the present embodiment.

FIG. 5 is a side view schematically illustrating a cutting tool of the shaping and cutting machine according to the present embodiment.

FIG. 6 is a schematic view of a cutting edge section of a cutting tool of the shaping and cutting machine according to the present embodiment.

FIG. 7 is a cross-sectional view schematically illustrating a cutting edge section of a cutting tool of the shaping and cutting machine according to the present embodiment.

FIG. 8 is a graph illustrating the durability of the cutting tools of a first embodiment, a first comparative example and a second comparative example.

### DESCRIPTION OF EMBODIMENTS

Hereinafter, a preferred embodiment of the present disclosure will be described in detail with reference to the drawings. The embodiments described below do not unduly limit the content of the disclosure described in the appended claims. In addition, all of the configurations described below are not necessarily essential constituent elements of the disclosure.

### 1. Shaping and cutting machine

### 1.1. Overall configuration

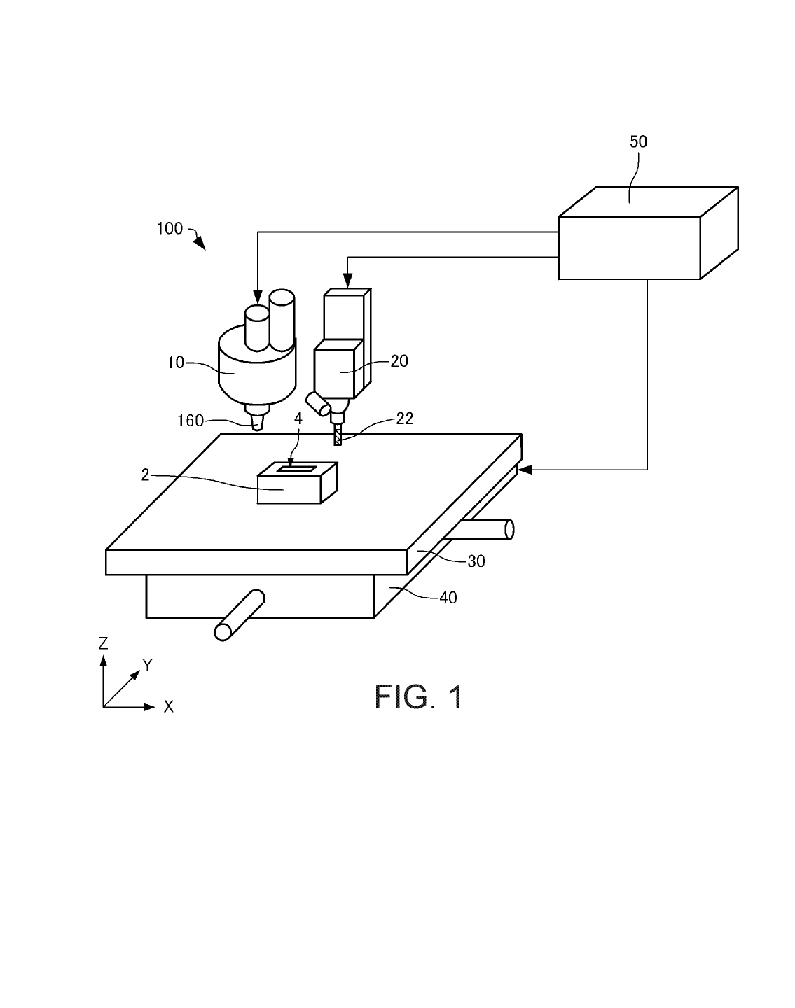

First, a shaping and cutting machine according to the present embodiment will be described with reference to the drawings. FIG. 1 is a cross-sectional view schematically illustrating a shaping and cutting machine 100 according to the present embodiment. In FIG. 1, an X-axis, a Y-axis, and a Z-axis are shown as three axes orthogonal to each other. The X-axis direction and the Y-axis direction are, for example, horizontal directions. The Z-axis direction is, for example, a vertical direction.

As illustrated in FIG. 1, the shaping and cutting machine 100 includes, for example, a molding section 10, a cutting section 20, a stage 30, a position changing section 40, and a control section 50.

In the shaping and cutting machine 100, the position changing section 40 is driven to change the relative position between the molding section 10 and the stage 30 while the plasticized resin material is discharged from the molding section 10 to the stage 30. By this, the molding section 10 shapes a molded body made of a resin material on the stage 30.

Further, in the shaping and cutting machine 100, the position changing section 40 is driven to change the relative position between a cutting tool 22 and the stage 30 while rotating the cutting tool 22 of the cutting section 20. By this, the cutting section 20 cuts the molded body formed on the stage 30 to mold a molded article 2.

The resin material discharged from the molding section 10 includes, for example, a thermoplastic resin. Examples of the thermoplastic resin include general-purpose plastics, general-purpose engineering plastics, and super engineering plastics.

Examples of the general-purpose plastic include acrylonitrile-butadiene styrene (ABS) resin, polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET).

Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyether ether ketone (PEEK).

The resin material discharged from the molding section 10 contains metal particles. A main component of the metal particles is, for example, iron (Fe). In other words, the metal particles have an iron content of 70 mass% or more. The metal particles are, for example, amorphous metal particles containing iron as the main component. The metal particles may contain cobalt (Co), nickel (Ni), silicon (Si), boron (B), chromium (Cr), tungsten (W), niobium (Nb), tantalum (Ta), titanium (Ti), zirconium (Zr), hafnium (Hf), or the like, in addition to the main component.

The shape of the metal particles contained in the resin material is, for example, spherical. The metal particles are formed by, for example, an atomizing method. By the atomizing method, spherical metal particles can be obtained. The content of the metal particles in the resin material is, for example, between 20 vol% and 40 vol% inclusive, preferably between 30 vol% and 40 vol% inclusive, and more preferably between 35 vol% and 40 vol% inclusive. The metal particles may be coated with a compatibilizer. The compatibilizer coated on the metal particles is, for example, a silane coupling agent. The material of the silane coupling agent is, for example, 3-mercaptopropyltrimethoxysilane.

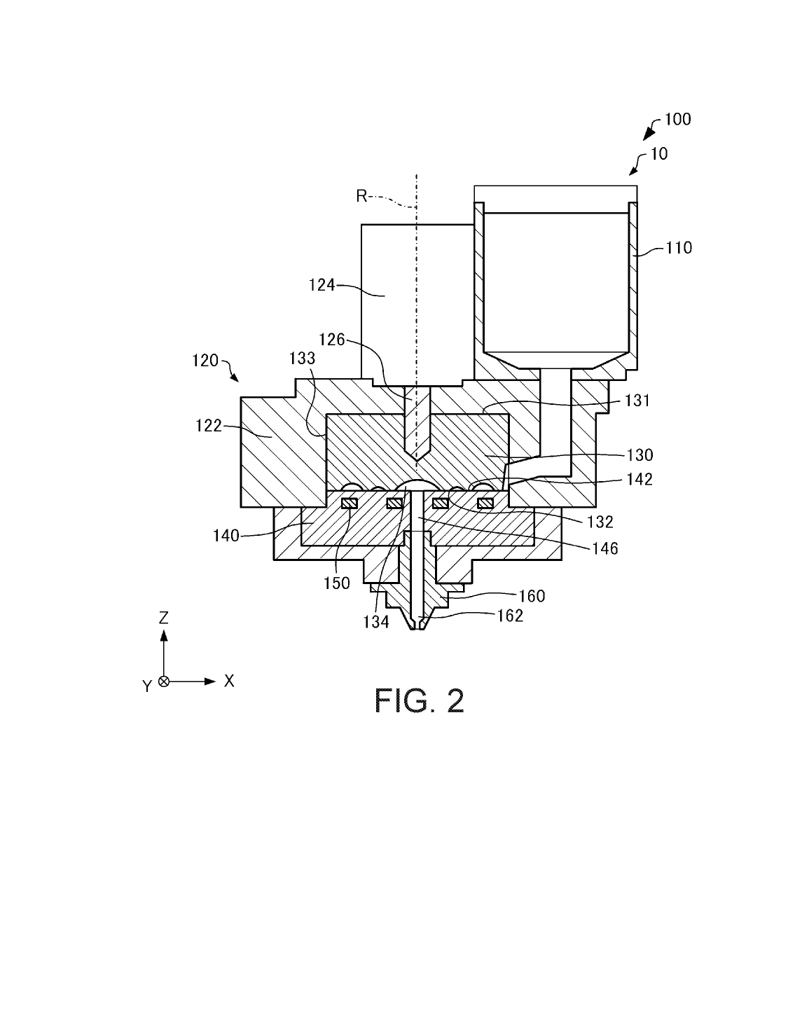

FIG. 2 is a cross-sectional view schematically illustrating the molding section 10. As illustrated in FIG. 2, the molding section 10 includes, for example, a material supply section 110, a plasticizing section 120, and a nozzle 160.

The material supply section 110 supplies the resin material to the plasticizing section 120. The material supply section 110 includes, for example, a hopper. The resin material supplied by the material supply section 110 is provided in pellet or powder form, for example.

The plasticizing section 120 includes, for example, a screw case 122, a drive motor 124, a flat screw 130, a barrel 140, and a heating section 150. The plasticizing section 120 plasticizes at least part of the resin material supplied in a solid state from the material supply section 110, generates a plasticized material that is pasty and fluid, and supplies it to the nozzle 160.

Plasticization is a concept including melting, and is to change from a solid state to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point.

The screw case 122 is a housing that houses the flat screw 130. The barrel 140 is provided on the bottom face of the screw case 122. The flat screw 130 is housed in a space surrounded by the screw case 122 and the barrel 140.

The drive motor 124 is provided on a top face of the screw case 122. The drive motor 124 is, for example, a servo motor. A shaft 126 of the drive motor 124 is coupled to a top face 131 of the flat screw 130. The drive motor 124 is controlled by the control section 50. Although not illustrated, the shaft 126 of the drive motor 124 and the top face 131 of the flat screw 130 may be coupled to each other via a decelerator.

The flat screw 130 has a substantially cylindrical shape in which the size in the direction of a rotation axis R is smaller than the size in the direction orthogonal to the direction of the rotation axis R. In the illustrated example, the rotation axis R is parallel to the Z-axis. The torque generated by the drive motor 124 causes the flat screw 130 to rotate about the rotation axis R.

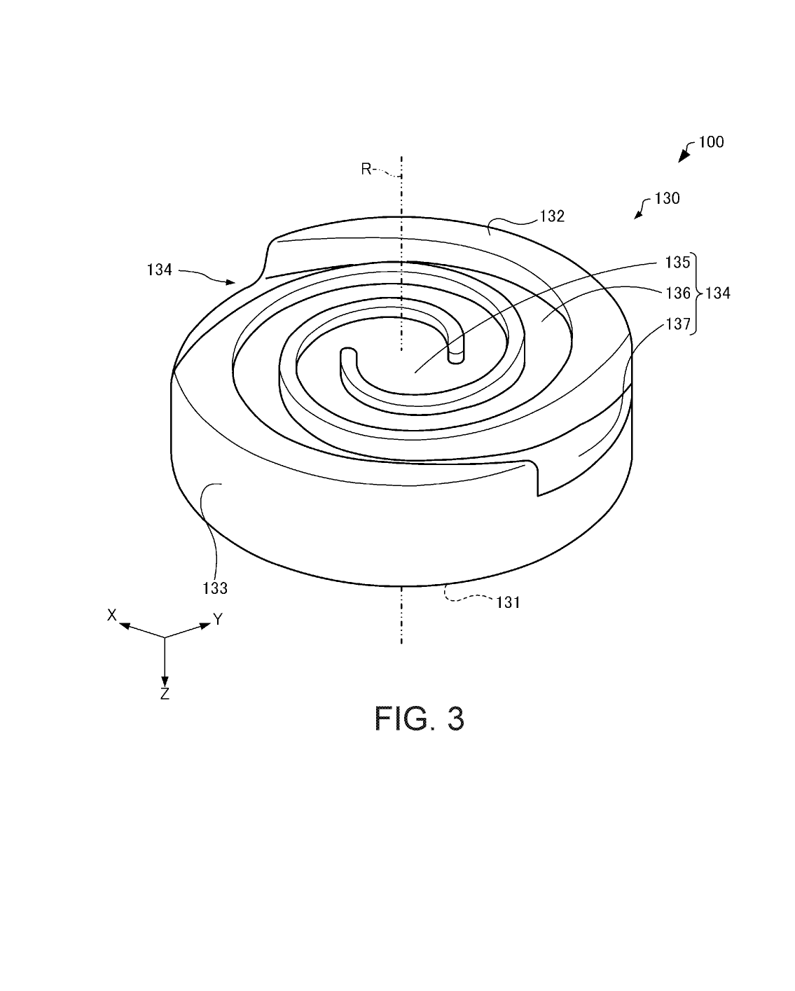

The flat screw 130 has the top face 131, a groove formed surface 132 on the opposite side from the top face 131, and a side face 133 coupling the top face 131 and the groove formed surface 132. A first groove 134 is formed in the groove formed surface 132. The side face 133 is, for example, perpendicular to the groove formed surface 132. FIG. 3 is a perspective view schematically illustrating the flat screw 130. For convenience’s sake, FIG. 3 shows a state in which the vertical positional relationship is reversed from that shown in FIG. 2.

As illustrated in FIG. 3, the first groove 134 is formed in the groove formed surface 132 of the flat screw 130. The first groove 134 includes, for example, a central section 135, a coupling section 136, and a material inlet section 137. The central section 135 faces a communication hole 146 formed in the barrel 140. The central section 135 communicates with the communication hole 146. The coupling section 136 couples the central section 135 and the material inlet section 137. In the illustrated example, the coupling section 136 is formed in a spiral shape from the central section 135 toward the outer periphery of the groove formed surface 132. The material inlet section 137 is formed on the outer periphery of the groove formed surface 132. That is, the material inlet section 137 is formed on the side face 133 of the flat screw 130. The material supplied from the material supply section 110 is introduced from the material inlet section 137 into the first groove 134, passes through the coupling section 136 and the central section 135, and is transported to the communication hole 146 formed in the barrel 140. For example, two first grooves 134 are formed.

Note that the number of first grooves 134 is not particularly limited. Although not shown, three or more first grooves 134 may be formed, or only one first groove may be formed.

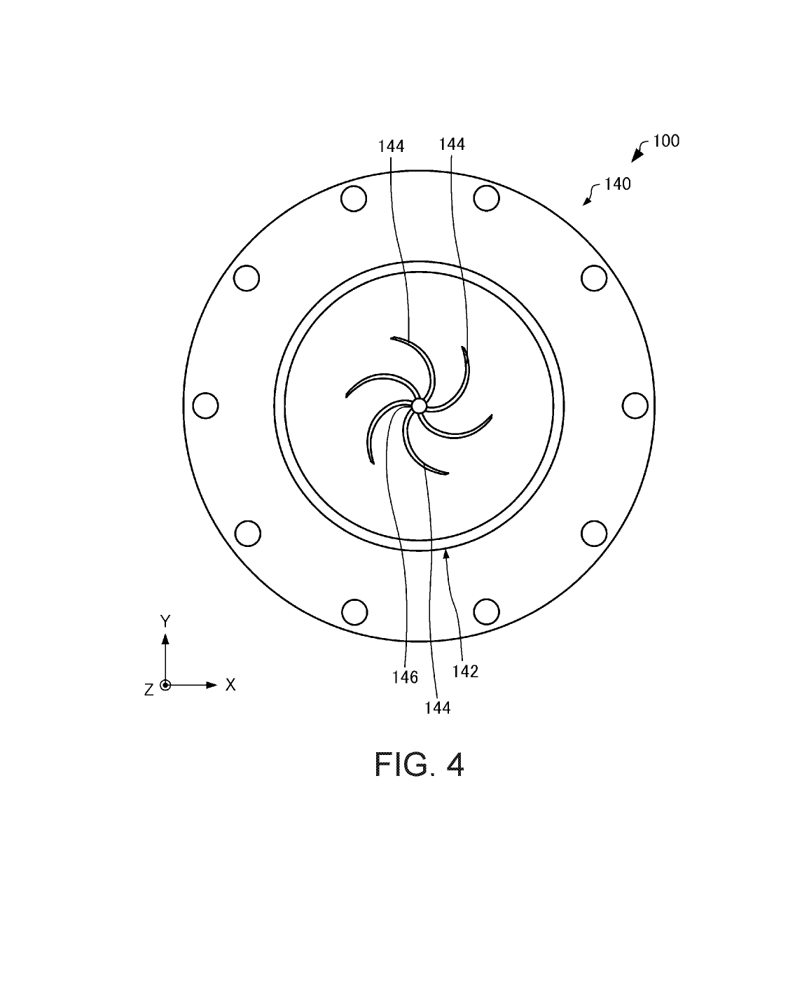

As illustrated in FIG. 2, the barrel 140 is provided below the flat screw 130. The barrel 140 has a facing face 142 that faces the groove formed surface 132 of the flat screw 130. The communication hole 146 communicating with the first groove 134 is formed at the center of the facing face 142. FIG. 4 is a plan view schematically illustrating the barrel 140.

As illustrated in FIG. 4, second grooves 144 and the communication hole 146 are formed in the facing face 142 of the barrel 140. A plurality of second grooves 144 is formed. In the illustrated example, six second grooves 144 are formed, but the number of second grooves 144 is not particularly limited. The plurality of second grooves 144 is formed around the communication hole 146 as viewed in the Z-axis direction. The second grooves 144 have one end coupled to the communication hole 146, and spirally extend from the communication hole 146 toward the outer periphery of the barrel 140. The second groove 144 has a function of guiding the plasticized material to the communication hole 146.

The shape of the second grooves 144 is not particularly limited, and may be, for example, linear. Further, one end of the second grooves 144 may not be coupled to the communication hole 146. Further, the second grooves 144 may not be formed in the facing face 142. However, in consideration of efficiently guiding the plasticized material to the communication hole 146, the second groove 144 is preferably formed in the facing face 142.

As illustrated in FIG. 2, the heating section 150 is provided in the barrel 140. The heating section 150 is a heater. The heating section 150 is, for example, a rod heater. The heating section 150 heats the resin material supplied between the flat screw 130 and the barrel 140. The output of the heating section 150 is controlled by the control section 50. The plasticizing section 120 heats the resin material while transporting the resin material toward the communication hole 146 by the flat screw 130, the barrel 140, and the heating section 150, and generates a plasticized material. Then, the plasticizing section 120 causes the generated plasticized material to flow out from the communication hole 146. The shape of the heating section 150 may be a ring shape when viewed from the Z-axis direction.

The heating section 150 may not be provided in the barrel 140, and may be provided in the flat screw 130, for example. Although not illustrated, the plasticizing section 120 may plasticize the resin material using an in-line screw that is long in the rotation axis direction instead of the flat screw 130.

The nozzle 160 is provided below the barrel 140. A nozzle aperture 162 is formed in the nozzle 160. The nozzle aperture 162 communicates with the communication hole 146. The plasticized resin material is supplied to the nozzle aperture 162 from the communication hole 146. The nozzle 160 discharges the plasticized resin material from the nozzle aperture 162 toward the stage 30. By this, the molding section 10 shapes the molded body on the stage 30.

As illustrated in FIG. 2, the cutting section 20 has the cutting tool 22. The cutting tool 22 is attached to a tip end of the cutting section 20 on the stage 30 side. The cutting section 20 rotates the cutting tool 22 to cut the molded body molded on the stage 30. The cutting section 20 cuts the molded body to mold the molded article 2 having a cavity 4, for example. The molded article 2 is used as, for example, a molding die of an injection molding device.

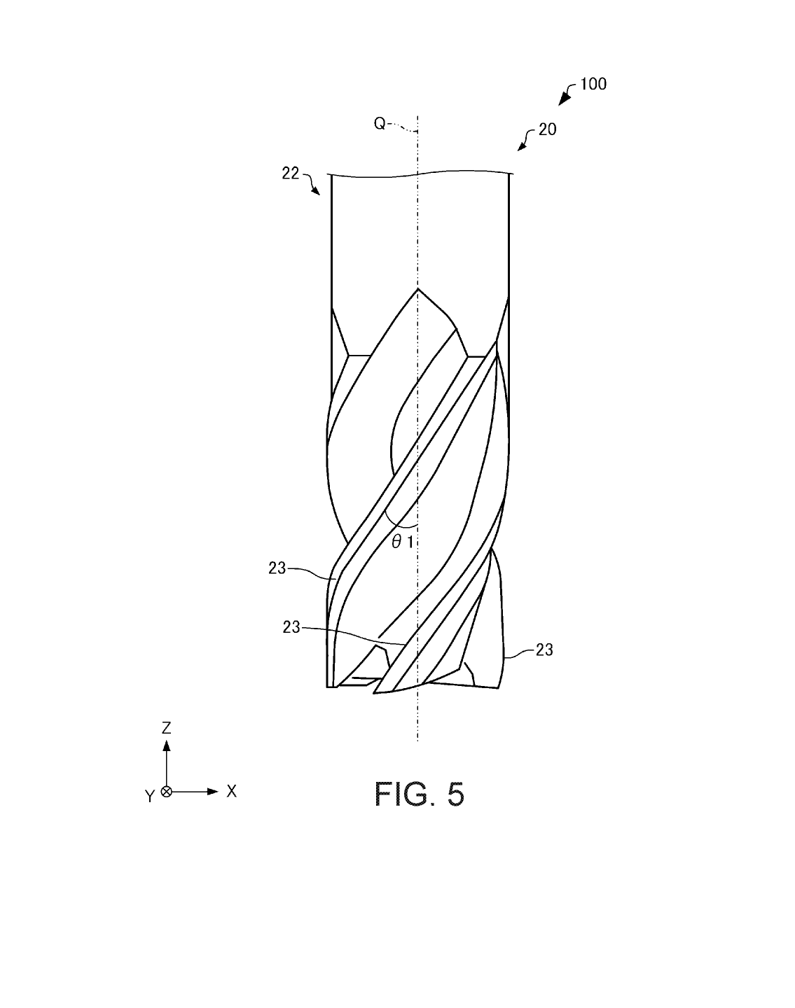

FIG. 5 is a side view schematically illustrating the cutting tool 22 of the cutting section 20. As illustrated in FIG. 5, the cutting tool 22 is, for example, a square end mill. The cutting tool 22 may be a roughing end mill or a radius end mill. The cutting tool 22 extends in the Z-axis direction. The cutting tool 22 is rotatable about a rotation axis Q. In the illustrated example, the rotation axis Q is parallel to the Z-axis. The control section 50 controls the position changing section 40 to change the relative position between the cutting tool 22 and the molded body formed on the stage 30, thereby controlling the cutting position.

The cutting tool 22 has a cutting edge section 23 for cutting the molded body. A plurality of cutting edge sections 23 is provided. The cutting edge section 23 is provided in a helical shape, for example. The helix angle θ1 of the cutting edge section 23 is, for example, between 15° and 45° inclusive. The helix angle θ1 is, for example, an inclination angle of the cutting edge section 23 with respect to the rotation axis Q when viewed from the Y-axis direction.

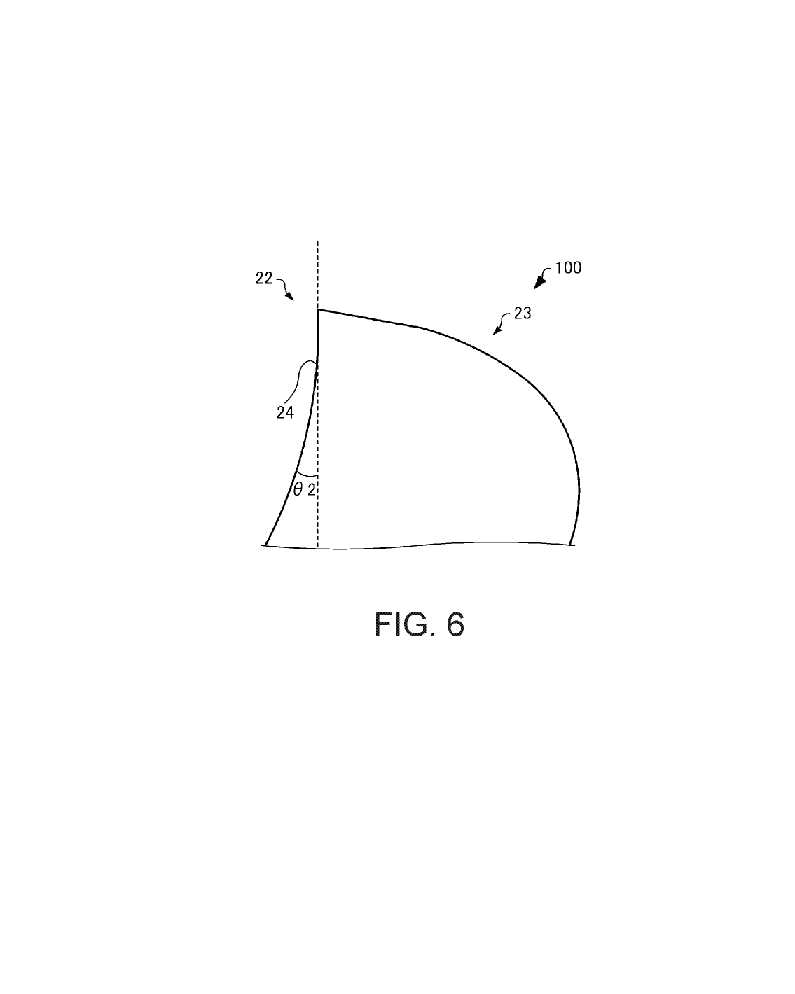

FIG. 6 is a view schematically showing the cutting edge section 23 of the cutting tool 22. As illustrated in FIG. 6, the cutting edge section 23 has a negative shape. In other words, the rake angle θ2 of the cutting edge section 23 is negative.

The rake angle θ2 of the cutting edge section 23 is, for example, between 5° and 15° inclusive. The rake angle is the angle between the face of the molded body being cut and a rake face 24 from which the cutting chips are shed when the cutting tool 22 scrapes against the molded body.

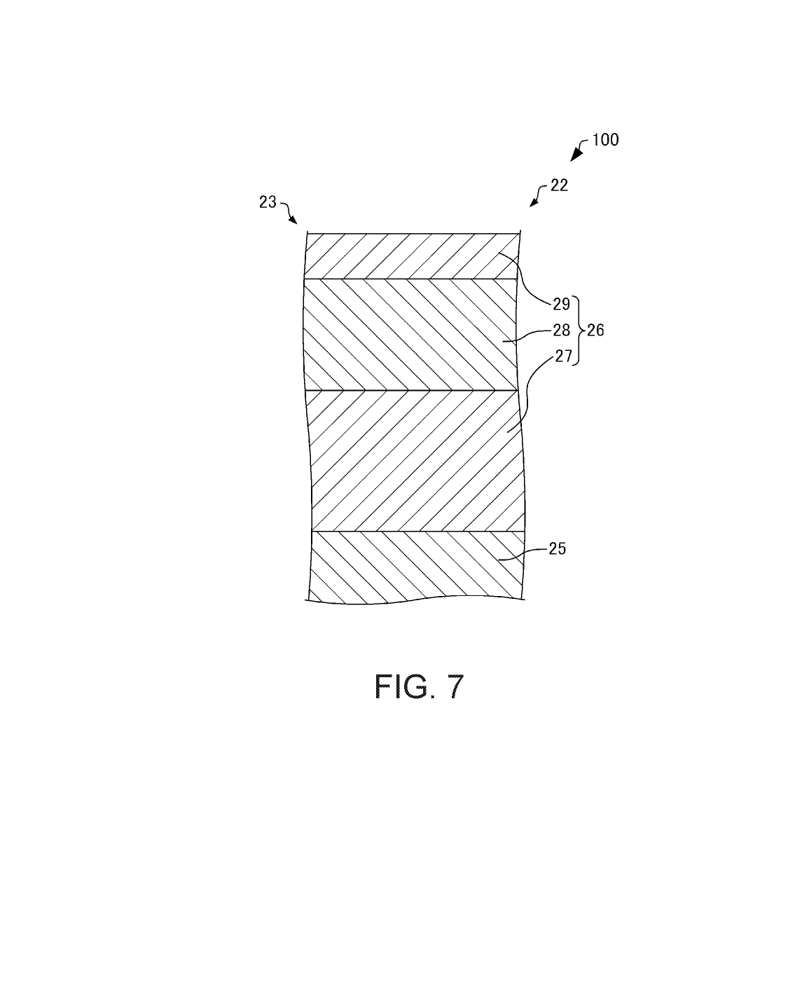

FIG. 7 is a cross-sectional view schematically illustrating the cutting edge section 23 of the cutting tool 22. As illustrated in FIG. 7, the cutting edge section 23 includes a base material 25 and a coating material 26. The material of the base material 25 is, for example, cemented carbide. As the cemented carbide, for example, WC-Co alloy is used.

The coating material 26 covers the base material 25. The coating material 26 covers, for example, the entire base material 25. The coating material 26 contains chromium and silicon. The coating material 26 is, for example, in the form of layers. The coating material 26 includes, for example, a first layer 27, a second layer 28, and a third layer 29.

The first layer 27 covers the base material 25. The first layer 27 is provided between the base material 25 and the second layer 28. The thickness of the first layer 27 is, for example, between 1000 nm and 3000 nm inclusive, preferably between 1500 nm and 2000 nm inclusive, and more preferably between 1600 nm and 1800 nm inclusive. The first layer 27 includes, for example, aluminum (Al), chromium (Cr), and nitrogen (N). The material of the first layer 27 may be an alloy of aluminum, chromium, and nitrogen.

The second layer 28 covers the first layer 27. The second layer 28 is provided between the first layer 27 and the third layer 29. The thickness of the second layer 28 is, for example, between 500 nm and 3000 nm inclusive, preferably between 1000 nm and 2000 nm inclusive, and more preferably between 1300 nm and 1500 nm inclusive. The second layer 28 includes, for example, titanium (Tl), silicon (Si), and nitrogen (N). The material of the second layer 28 may be an alloy of titanium, silicon, and nitrogen.

The third layer 29 covers the second layer 28. The thickness of the third layer 29 is, for example, between 100 nm and 500 nm inclusive, preferably between 200 nm and 400 nm inclusive, and more preferably between 250 nm and 350 nm inclusive. The third layer 29 includes, for example, chromium (Cr), aluminum (Al), and nitrogen (N). The material of the third layer 29 may be an alloy of chromium, aluminum, and nitrogen. The total of the thickness of the first layer 27, the thickness of the second layer 28, and the thickness of the third layer 29 is, for example, between 3300 nm and 3500 nm inclusive. The thickness of the first layer 27, the thickness of the second layer 28, and the thickness of the third layer 29 are measured by, for example, a scanning electron microscope (SEM). The first layer 27, the second layer 28, and the third layer 29 are formed by, for example, a physical vapor deposition (PVD) method.

As illustrated in FIG. 1, the molded article 2 is disposed on the stage 30. In the illustrated example, the molded article 2 is provided directly on the stage 30. Although not shown, the molded article 2 may be provided on the stage 30 via a predetermined plate.

The position changing section 40 supports the stage 30. In the illustrated example, the position changing section 40 is configured as a three axis positioner that moves the stage 30 along three axes orthogonal to each other with respect to the molding section 10 and the cutting section 20.

The position changing section 40 may move the molding section 10 and the cutting section 20 with respect to the stage 30 without moving the stage 30. The position changing section 40 may move both the stage 30 and the molding section 10 and the cutting section 20. For example, the position changing section 40 may move the stage 30 in the X-axis direction and the Y-axis direction, and move the molding section 10 and the cutting section 20 in the Z-axis direction.

The position changing section 40 may have a function of inclining the stage 30 with respect to a horizontal plane.

The position changing section 40 may have a function of inclining nozzle 160 and the cutting tool 22 relative to the horizontal plane.

The control section 50 is configured by a computer comprising, for example, a processor, a main storage device, and an input/output interface for exchanging signals with external devices. The control section 50 controls the molding section 10, the cutting section 20, and the position changing section 40 by, for example, the processor executing a program read into the main storage device. The control section 50 may be configured by a combination of a plurality of circuits instead of the computer.

### 1.2. Operational effects

The shaping and cutting machine 100 includes the molding section 10 that discharges a resin material containing metal particles and that molds a molded body and the cutting section 20 that cuts the molded body to form the molded article 2. The molding section 10 includes the plasticizing section 120 that plasticizes the resin material and the nozzle 160 for discharging the plasticized resin material. The cutting section 20 includes the cutting tool 22 having the cutting edge section 23 for cutting the molded body.

The cutting edge section 23 includes the base material 25 and the coating material 26 that coats the base material 25 and contains chromium and silicon. As described above, in the shaping and cutting machine 100, the coating material 26, which contains chromium and silicon, can improve toughness and wear resistance compared to, for example, a diamond-based coating material. As a result, damage and wear to the cutting tool 22 can be effectively suppressed. By this, it possible to improve the durability of the cutting tool 22 and to extend the life of the cutting tool 22. As a result, the replacement cycle of the cutting tool 22 is extended, and the manufacturing cost can be reduced.

In the shaping and cutting machine 100, the material of the base material 25 is cemented carbide. Therefore, in the shaping and cutting machine 100, slidability and adhesion resistance can be improved, and even if cutting chips of the resin material melted by heat during cutting are generated, the possibility of damage to the cutting tool 22 by the cutting chips can be reduced.

In the shaping and cutting machine 100, the cutting edge section 23 has a negative shape. Therefore, in the shaping and cutting machine 100, it is possible to suppress the occurrence of damage or wear of the cutting tool 22.

In the shaping and cutting machine 100, the rake angle θ2 of the cutting edge section 23 is between 5° and 15° inclusive. Therefore, in the shaping and cutting machine 100, it is possible to ensure sufficient sharpness for cutting the resin material while suppressing the occurrence of damage and wear of the cutting tool 22. The rake angle of the negative-shaped cutting edge section is generally 3°, and in the shaping and cutting machine 100, the rake angle θ2 of the cutting edge section 23 is larger than 3°, and therefore, the durability can be improved.

In the shaping and cutting machine 100, the helix angle θ1 of the cutting edge section 23 is between 15° and 45° inclusive.

Therefore, in the shaping and cutting machine 100, it is possible to suppress the occurrence of micro-vibration of the cutting tool 22 during cutting, and it is possible to suppress the occurrence of damage or wear to the cutting tool 22 due to unintended contact with the molded body. As the helix angle θ1 increases, the cutting chips become thinner and are more likely to be discharged, and the possibility of damage to the cutting tool 22 by the cutting chips can be reduced.

In the shaping and cutting machine 100, the main component of the metal particles is iron. In the shaping and cutting machine 100, in cutting of a resin material containing iron that has high hardness and is likely to cause damage or wear of the cutting tool during cutting, it is possible to suppress occurrence of damage or wear particularly in the cutting tool 22. Iron has a 1000 HV Vickers hardness and a high hardness.

### 2. Embodiment and comparative examples

### 2.1. Material of cutting tool

As the first embodiment, a cutting tool was used that has a cutting edge section portion in which a base material was coated with a coating material. The base material was a WC-Co alloy. The coating material includes a first layer covering the base material, a second layer covering the first layer, and a third layer covering the second layer. The material of the first layer was an alloy composed of aluminum, chromium, and nitrogen. The material of the second layer was an alloy composed of titanium, silicon, and nitrogen. The material of the third layer was an alloy composed of chromium, aluminum, and nitrogen. The thickness of the first layer was taken as 1700 nm. The thickness of the second layer was from 1300 nm to 1500 nm. The thickness of the third layer was taken as 300 nm.

As a first comparative example, a cutting tool was used that has a cutting edge section in which a base material was coated with a coating material. The base material was a WC-Co alloy. As the coating material, DLC (Diamond-Like Carbon) was used.

As a comparative example 2, a cutting tool having a cutting edge section not coated with a coating material was used. The base material was a WC-Co alloy. The cutting tools of first embodiment, the first comparative example, and the second comparative example are square end mills.

### 2.2 Evaluation of durability of cutting tool

Using the cutting tools described above, a target workpiece was cut for a total length of 160 m. Afterward, the diameter of the workpiece was measured at a position 0.25 mm from the tip end of the cutting tools using a laser measuring machine, in order to evaluate the durability of the cutting tools. As the target workpiece, a PPS to which metal particles were added was used. As the metal particles, atomized powder "KUAMET" manufactured by Epson Atmix Corporation was used.

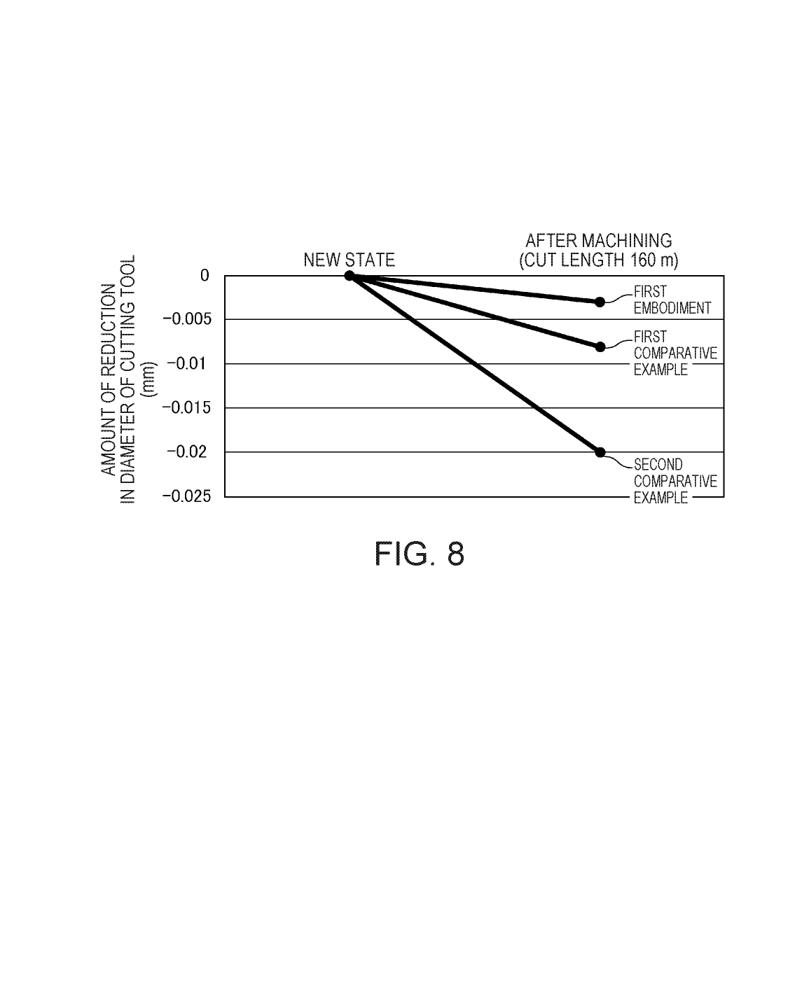

FIG. 8 is a graph illustrating durability of a cutting tool. The vertical axis of FIG. 8 represents the amount of decrease in diameter from the diameter of the target workpiece before cutting, that is, the diameter of the workpiece in a new state, which is normalized as 0. As illustrated in FIG. 8, the amount of decrease in diameter was smaller in the case first embodiment than in the case of the first comparative example and in the second comparative example. It was found that first embodiment had higher durability than the first comparative example and the second comparative example.

The above-described embodiments and modifications are merely examples, and it is not limited thereto. For example, it is possible to appropriately combine the embodiments and the modifications.

The disclosure includes a configuration substantially the same as the configuration described in the embodiment, for example, a configuration having the same function, method, and result, or a configuration having the same object and effect. The disclosure includes a configuration in which a non-essential part of the configuration described in the embodiment is replaced. The disclosure includes a configuration that achieves the same operational effects as the configuration described in the embodiment or a configuration that can achieve the same object. The disclosure includes a configuration in which a known technique is added to the configuration described in the embodiment.

The following contents are derived from the above-described embodiments and modifications.

One aspect of the shaping and cutting machine includes a molding section that discharges a resin material containing metal particles and that molds a molded body and a cutting section that cuts the molded body and that forms a molded article, wherein the molding section has a plasticizing section that plasticizes the resin material and a nozzle that discharges the plasticized resin material, the cutting section includes a cutting tool having a cutting edge section that cuts the molded body, and the cutting edge section has a base material and a coating material that coats the base material and that contains chromium and silicon.

According to this shaping and cutting machine, it is possible to achieve a long life.

An aspect of the shaping and cutting machine may be such that the material of the base material is cemented carbide.

According to this shaping and cutting machine, slidability and adhesion resistance can be improved.

An aspect of the shaping and cutting machine may be such that the cutting edge section includes a negative shape.

According to this shaping and cutting machine, it is possible to suppress the occurrence of damage and wear of the cutting tool.

An aspect of the shaping and cutting machine may be such that a rake angle of the cutting edge section is between 5° and 15° inclusive.

In the shaping and cutting machine, it is possible to ensure sufficient sharpness for cutting the resin material while suppressing the occurrence of damage and wear of the cutting tool.

An aspect of the shaping and cutting machine may be such that a helix angle of the cutting edge section is between 15° and 45° inclusive.

In the shaping and cutting machine, it is possible to suppress the occurrence of micro-vibration of the cutting tool during cutting.

An aspect of the shaping and cutting machine may be such that a main component of the metal particles is iron.

According to this shaping and cutting machine, in cutting of a resin material containing iron which has high hardness and is likely to cause damage or wear of the cutting tool during cutting, it is possible to suppress occurrence of damage or wear particularly in the cutting tool.

What is claimed is:

1. A shaping and cutting machine comprising:
a molding section that discharges a resin material containing metal particles and that molds a molded body and
a cutting section that cuts the molded body and that forms a molded article, wherein
the molding section includes
a plasticizing section that plasticizes the resin material and
a nozzle that discharges the plasticized resin material,
the cutting section includes a cutting tool having a cutting edge section that cuts the molded body, and
the cutting edge section includes
a base material and
a coating material that coats the base material and that contains chromium and silicon.

2. The shaping and cutting machine according to claim 1, wherein
the material of the base material is cemented carbide.

3. The shaping and cutting machine according to claim 1, wherein
the cutting edge section includes a negative shape.

4. The shaping and cutting machine according to claim 1, wherein
a rake angle of the cutting edge section is between 5° and 15° inclusive.

5. The shaping and cutting machine according to claim 1, wherein
a helix angle of the cutting edge section is between 15° and 45° inclusive.

6. The shaping and cutting machine according to claim 1, wherein
a main component of the metal particles is iron.
